(19) United States
(12) Patent Application Publication
(10) Pub. No.: US 2024/0009691 A1
(43) Pub. Date: Jan. 11, 2024

(54) FAN AIR LEVER FOR A SPRAY GUN

(71) Applicant: Graco Minnesota Inc., Minneapolis, MN (US)

(72) Inventor: Mark C. Richter, River Falls, WI (US)

(21) Appl. No.: 18/025,288

(22) PCT Filed: Sep. 13, 2021
(86) PCT No.: PCT/US21/50031

§ 371 Date: Mar. 8, 2023

Related U.S. Application Data
(60) Provisional application No. 63/079,027, filed on Sep. 16, 2020.

(51) Int. Cl. B05B 7/08; B05B 12/00; B05B 7/12

(52) U.S. Cl. CPC B05B 7/0815; B05B 12/002; B05B 7/12

(57) ABSTRACT

A fan air control assembly for a spray gun (10) controls the flow rate of a fan air portion of compressed air to the spray end of the spray gun (10), thereby controlling the resulting spray pattern. The fan air lever (28) is accessible from the exterior of the spray gun (10) and can be manipulated while spraying by the hand of the user holding the sprayer and manipulating the trigger. The fan air control assembly (20) is rotatable on a valve axis (B) to control the flow of the fan air portion.

### CROSS-REFERENCE TO RELATED APPLICATION(S)

This application claims priority to U.S. Provisional Application No. 63/079,027 filed on Sep. 16, 2020, and entitled “FAN AIR LEVER FOR A SPRAY GUN,” the disclosure of which is hereby incorporated by reference in its entirety.

### BACKGROUND

This disclosure relates generally to sprayers. More specifically, this disclosure relates to fan air control for sprayers.

Spray guns can be used to spray fluids on surfaces. For example, spray guns can be used to spray paint, lacquer, finishes, and other coatings on furniture, cabinets, appliances, equipment, fabricated components, etc. While various fluids can be sprayed by the embodiments referenced herein, paint will be used as an example. Typically, the paint is placed under pressure by a piston, diaphragm, or other positive displacement pump. The pump can place the paint under pressure between 500 to 5,000 pounds per square inch (psi), although higher and lower pressures are possible. The pump outputs the paint under pressure through a flexible hose. A spray gun is used to dispense the paint, the gun being attached to the end of the hose opposite the pump. In this way, the spray gun does not include a pump, but rather releases paint pumped to the spray gun through the hose. The spray gun atomizes the paint under pressure into a spray fan, which is applied to a surface.

Some spray guns emit flows of compressed air to assist in atomizing and/or shaping the fluid spray. That fan air can control the spray pattern and/or assist in the atomization of the spray fluid. Such spray guns emit fluid through a spray nozzle and emit the airflows proximate the fluid spray.

### SUMMARY

According to an aspect of the disclosure, a fan air control assembly for a spray gun is configured to control flow of a fan air portion of compressed air to a spray end of the spray gun, the fan air portion configured to shape a spray pattern emitted by the spray gun. The fan air control assembly includes a fan lever and a valve assembly operably connected to the fan lever. The valve assembly includes a valve mount having a shaft bore extending axially therethrough along a valve axis and a valve member. The valve mount includes a mount body; a position body extending from the mount body in a first axial direction; and a flow control body extending from the mount body in a second axial direction, wherein at least one flow opening extends through the flow control body. The valve member is disposed at least partially within the shaft bore and fixed to the fan lever. The valve member includes a shaft body having a flow controller disposed within a flow control body of the valve mount, the flow controller including at least one flow blocker extending at least partially about the valve axis and at least one flow passage. The valve member is rotatable on the valve axis to actuate the valve assembly between a maximum flow state and a minimum flow state.

According to an additional or alternative aspect of the disclosure, a method of controlling a fan air flow during spraying with a fluid sprayer includes grasping, with a first hand, a handle of the fluid sprayer; actuating, with the first hand, a trigger of the fluid sprayer to cause the fluid sprayer to emit a liquid spray; depressing, with the first hand, a fan lever projecting from a lateral side of a gun body of the fluid sprayer from a first position associated with a base state to a second position associated with an actuated state, the fan lever connected to a valve member to rotate the valve member on a valve axis thereby altering a flow of fan air to a spray end of the fluid sprayer; and releasing, with the first hand, the fan lever.

According to another additional or alternative aspect of the disclosure, a method of forming a fan air controller for a sprayer includes passing an axially elongate valve member through a shaft bore extending through a valve mount; inserting a rotation limiter into a rod opening in the valve member, the rotation limiter disposed in a rotation notch formed in the valve mount, wherein the rotation notch limits travel of the rotation limiter in a first circumferential direction and a second circumferential direction; connecting the valve mount to a spray gun by interfaced threading; placing a spring on the valve mount such that a first spring arm of the spring is disposed in a valve groove formed on the valve mount; placing a fan lever over a portion of the valve member projecting from the valve mount and such that a second spring arm of the spring is disposed in a lever groove formed on the fan lever; rotating the fan lever in a first circumferential direction to a first position associated with an actuated state; fixing the fan lever to the valve member with the fan lever in the first position; and rotating the fan lever and valve member from the first position to a second position associated with a base state by the spring.

### BRIEF DESCRIPTION OF THE DRAWINGS

FIG. 1 is an isometric view of a sprayer.

FIG. 2A is a first isometric exploded view of a fan air control assembly.

FIG. 2B is a second isometric exploded view of the fan air control assembly shown in FIG. 2A.

FIG. 3 is a cross-sectional view of the fan air control assembly mounted to the sprayer, taken along line 3-3 in FIG. 1.

FIG. 4 is an isometric view showing the valve assembly of the fan air control assembly mounted to the sprayer.

FIG. 5A is an elevation view showing the fan lever in a first position.

FIG. 5B is an elevation view showing the fan lever in a second, actuated state.

FIG. 5C is an elevation view showing the fan lever in a third, base state.

### DETAILED DESCRIPTION

The present disclosure relates generally to fan air control for sprayers. A fan air lever of the present disclosure provides simple, quick, responsive control for fan air used during spraying. A fan portion of compressed air is configured to shape the spray pattern emitted by the spray gun. The spray fluid is emitted through a spray tip and the fan portion of the compressed air can be emitted through an air cap surrounding the spray tip. The fan air lever of the present disclosure can be manipulated by a single hand of the user that is also manipulating the spray gun during spraying. The fan air lever allows for feathering of the fan air between the minimum and maximum flows and can maintain the fan air flow at the desired flow rate, in some examples. The fan air lever is easily operated while the gun is spraying and being held in the user's hand by depressing the fan air lever and releasing the fan air lever allowing the lever to spring back to the fan air on position. The fan air lever can automatically return the fan air flow to the desired flow rate upon release.

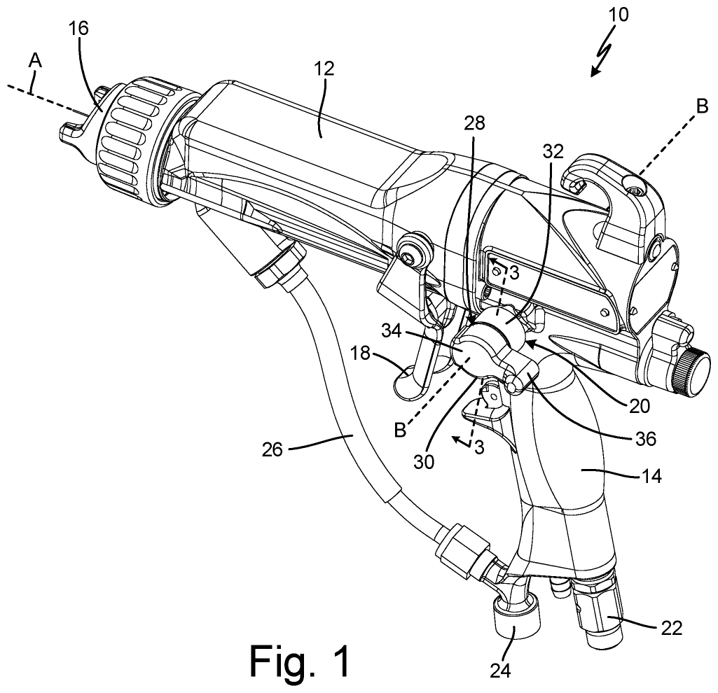

FIG. 1 is an isometric view of sprayer 10. Sprayer 10 includes gun body 12, handle 14, air cap 16, trigger 18, fan air control assembly 20, air inlet 22, fluid inlet 24, and fluid tube 26. Fan lever 28 of fan air control assembly 20 is shown. Fan lever 28 includes lever cap 30 and adaptor 32.

Sprayer 10 is configured to receive spray fluid and compressed air and to emit fluid sprays. For example, sprayer 10 can be used to spray paint, lacquer, finishes, and other coatings on furniture, cabinets, appliances, equipment, fabricated components, etc. While various liquids can be sprayed by the embodiments referenced herein, paint will be used as an example. While sprayer 10 is shown as an electrostatic sprayer in FIG. 1, it is understood that sprayer 10 can be of any desired configuration for generating and applying liquid sprays.

Gun body 12 supports various components of spray gun 10. Gun body 12 can be formed from a single components or multiple components connected together. Air cap 16 is disposed at the spray end of gun body 12 and is configured to emit compressed air proximate the nozzle that atomizes the fluid spray. The compressed air can provide a fan air portion of compressed air that interacts with the liquid spray to shape the spray pattern. In some examples, the full volume of compressed air provided to sprayer 10 is utilized as the fan air portion. The fan air portion controls the width of the spray fan emitted by the spray gun. For example, controlling the fan air to a minimum flow, which can be no flow in some examples, decreases a width of the spray pattern and causes a more circular spray pattern, whereas increasing the fan air flow increases the width of the spray pattern generating a flatter, wider pattern. For example, the minimum fan air flow can cause a circular spray pattern and the maximum fan air flow can cause an elongate oval pattern. Sprayer 10 is configured to emit the spray fluid along spray axis A. For example, the circular or elongate spray patterns can be centered on spray axis A.

Handle 14 extends from gun body 12. In the example shown, handle 14 is integrally formed as a portion of gun body 12. It is understood, however, that handle 14 can be formed separately from gun body 12 and be removably or permanently connected to gun body 12. Handle 14 can be considered to form a part of the gun body 12. Handle 14 can be grasped by a hand of the user to allow the user to manipulate and orient sprayer 10. Trigger 18 extends from gun body 12. Trigger 18 is configured to actuate one or more valves (not shown) disposed within gun body 12 to control flow of the spray liquid to and through a spray orifice. The trigger 18 thereby controls spraying by sprayer 10. Trigger 18 is disposed to be manipulated by the hand of the user that also grasps handle 14.

In the example shown, sprayer 10 is configured to receive both spray liquid and compressed air at the lower distal end of the handle 14. Fluid inlet 24 is a fitting configured to connect to a tube extending from a fluid supply, such as from a pump, such as a piston pump. Fluid tube 26 extends between fluid inlet 24 and the front end of gun body 12 through which the liquid spray is emitted. It is understood that in other examples sprayer can include and/or support the fluid source. For example, a reservoir (e.g., bag, cup, etc.) can be store the spray liquid and be mounted to gun body 12.

Air inlet 22 is a fitting disposed at a lower distal end of handle 14. Air inlet 22 is configured to connect to a tube extending from an air supply, such as an air compressor, tank of compressed air, etc. The compressed air flows through handle 14 and gun body 12 and to air cap 16.

Fan air control assembly 20 is mounted to gun body 12 and configured to control flow of the fan air portion to the spray end of sprayer 10. Fan air control assembly 20 is actuatable to control the fan air output by sprayer 10. In some examples, fan air control assembly 20 can be configured to actuate the fan air flow between a minimum flow state and a maximum flow state. Fan air control assembly 20 extends from a lateral side of gun body 12. Fan air control assembly 20 is cantilevered from the lateral side of gun body 12. In the example shown, fan air control assembly 20 is configured to rotate about valve axis B between the minimum flow position associated with minimum fan air flow and the maximum flow position associated with maximum fan air flow.

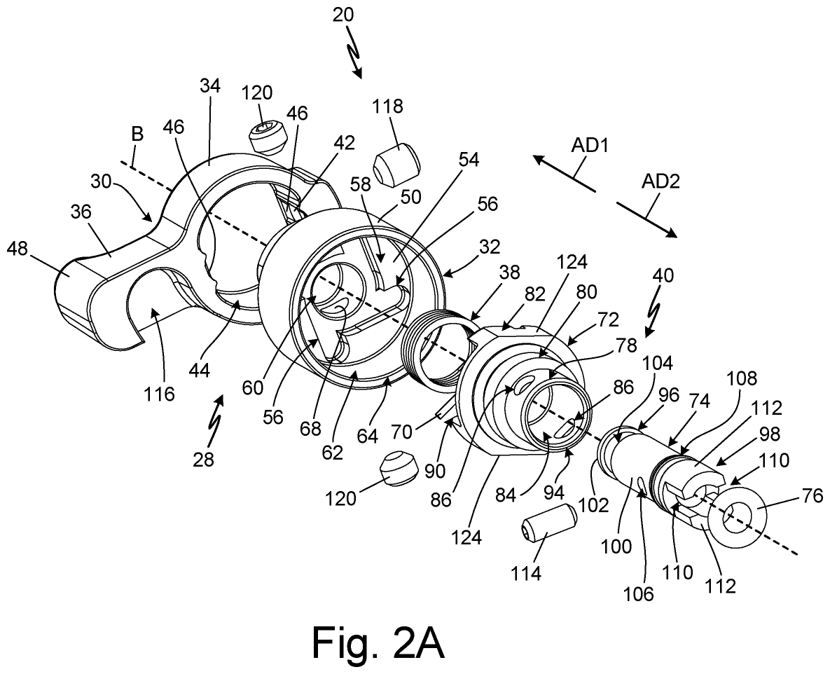

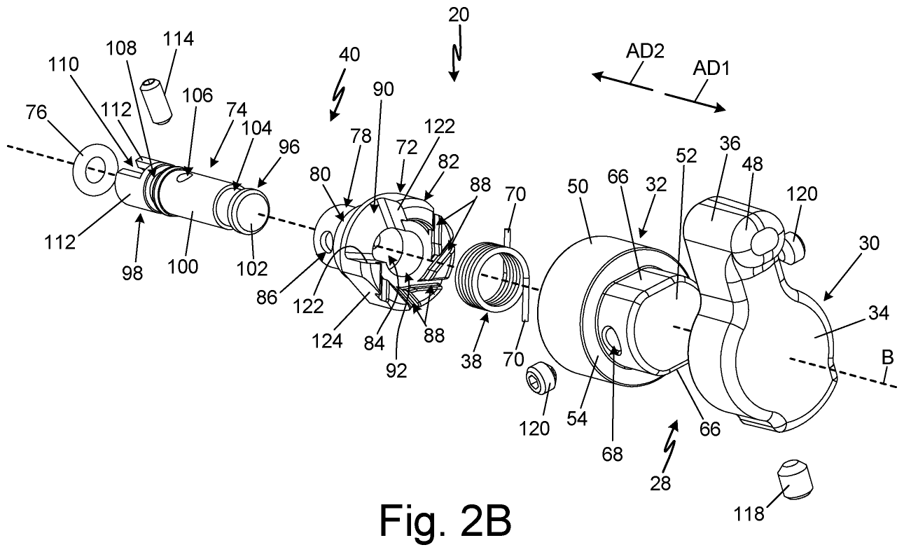

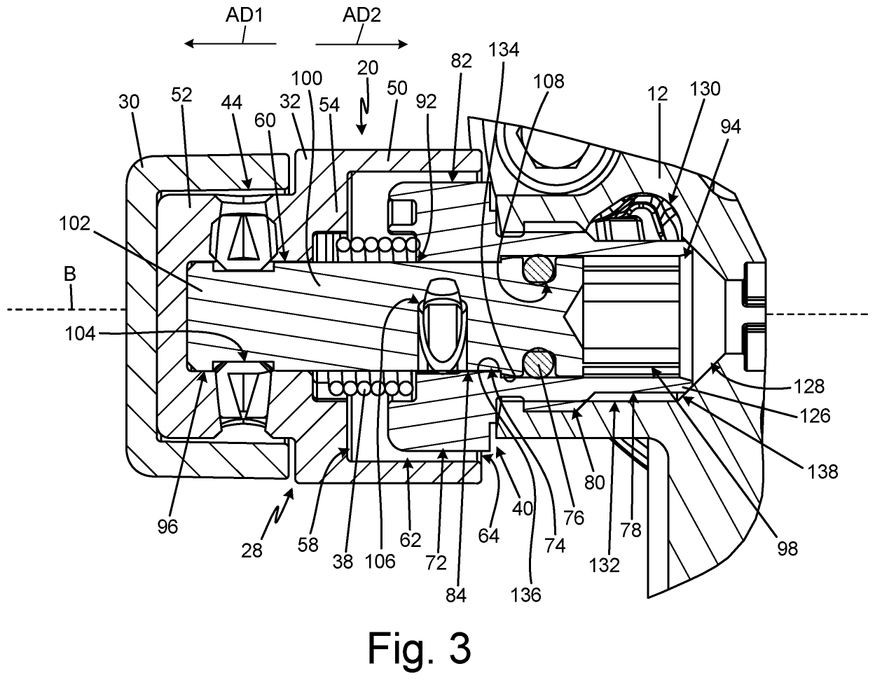

Fan lever 28 is disposed on an exterior of sprayer 10 and extends laterally away from the lateral side of gun body 12. In the example shown, fan lever 28 includes adaptor 32 that is connected to a valve member 74 (best seen in FIGS. 2A-3B) that extends into gun body 12 and the fan air pathway through gun body 12 to control the flow of the fan air. Lever cap 30 is connected to adaptor 32. Lever cap 30 includes lever arm 36 that extends from the lever body 34 of lever cap 30. Lever arm 36 extends away from valve axis B. Lever body 34 interfaces with adaptor 32. Lever cap 30 and adaptor 32 are fixed together such that rotating lever cap 30 about valve axis B rotates adaptor 32 about valve axis B, which rotates the fan air control valve member 74 about axis B to alter the flow of the fan air portion. Lever cap 30 and adaptor 32 can be formed as a single component or as multiple components fixed together. In some examples, lever cap 30 and adaptor 32 are removably connected such that the parts can be disconnected without destroying the operability of fan lever 28.

Sprayer 10 is operable by a single hand of the user. Fan air control assembly 20 is positioned such that fan air control assembly 20 is actuatable by the hand of the user that is also grasping handle 14. Lever arm 36 projects from lever body 34, radially relative to axis B, and provides a projection for the user to interface with to cause rotation of lever cap 30 about the axis B. Lever arm 36 spaces the point at which the user exerts the rotational force on fan lever 28 from the axis B. Lever arm 36 thereby facilitates the user exerting less force on fan lever 28 to drive rotation about valve axis B, thereby facilitating the use of a single digit for manipulation, such as the user's thumb.

The user can grasp handle 14, actuate trigger 18 to control spraying, and manipulate fan air control assembly 20 to control the output of fan air with the same hand at the same time. For example, the user can grasp handle 14 and wrap one or more of the user's fingers around the trigger 18. The user can pull trigger 18 with the fingers interfacing with the trigger 18 to cause spraying of the spray fluid. With the same hand that is manipulating trigger 18, the user can rotate fan lever 28 about axis B by interfacing with lever arm 36 with the thumb of the hand also manipulating trigger 18 and grasping handle 14. For example, the user can press on the top of the lever arm 36 to cause rotation about axis B. While sprayer 10 is shown in a right-hand configuration, with fan lever 28 on a left lateral side of gun body 12 such that the thumb of the user's right hand is positioned to interface with fan lever 28 during right-handed spraying, it is understood that sprayer can additionally or alternatively have a left-hand configuration, with fan lever 28 on a right lateral side of gun body 12 such that the thumb of the user's left hand is positioned to interface with fan lever 28 during left-handed spraying.

Fan air control assembly 20 provides significant advantages. The user can actively manipulate the fan air flow while actively emitting liquid spray with sprayer 10. Other fan air controls include needle and other valving that requires the user to stop spraying and actively change the fan air before resuming spraying. Fan air control assembly 20 allows the user to actively feather the fan air during spraying, providing direct visual feedback on the pattern being output and thus greater user confidence and less material waste due to testing pattern shapes after adjustments. The user can place and hold the fan air flow at a desired rate, including the maximum flow rate, the minimum flow rate, and any intermediate flow rate between the maximum and minimum flow rates. Fan air control assembly 20 decreases downtime and increase spray operation efficiency as the fan air can be actively controlled during spraying by an ergonomic, easy to use assembly for adjusting the flow of the fan air.

FIG. 2A is a first isometric exploded view of fan air control assembly 20. FIG. 2B is a second isometric exploded view of fan air control assembly 20. FIGS. 2A and 2B will be discussed together. Fan air control assembly 20 includes fan lever 28, spring 38, and valve assembly 40. Fan lever 28 includes lever cap 30 and adaptor 32. Lever cap 30 includes lever body 34, lever arm 36, fixture opening 42, receiving chamber 44, and chamber flats 46. Lever arm 36 includes knob 48. Adaptor 32 includes adaptor body 50, adaptor projection 52, lever wall 54, lever grooves 56, valve chamber 58, outer chamber inner chamber 62, adaptor opening 64, adaptor flats 66, fixture openings 68. Spring 38 includes spring legs 70. Valve assembly 40 includes valve mount 72, valve member 74, and valve seal 76. Valve mount 72 includes flow control body 78, mount body 80, position body 82, shaft bore 84, flow openings 86, valve grooves 88, and rotation notch 90. Shaft bore 84 includes first axial end 92 and second axial end 94. Valve member 74 includes connector 96, flow controller 98, shaft body 100, head 102, mount groove 104, rod opening 106, seal groove 108, flow passages 110, flow blockers 112, and rotation limiter 114.

Fan air control assembly 20 is configured to control the flow of the fan air portion of the compressed air to spray end of sprayer 10 (e.g., to the air cap 16). Fan lever 28 interfaces with valve assembly 40 to actuate valve member 74 and thereby alter a flow rate of the fan air portion. Fan lever 28 is configured to actuate valve member 74 relative to valve mount 72 to control a state of valve assembly 40, thereby controlling a state of fan air control assembly 20. In the example shown, fan lever 28 is configured to rotate valve member on axis B.

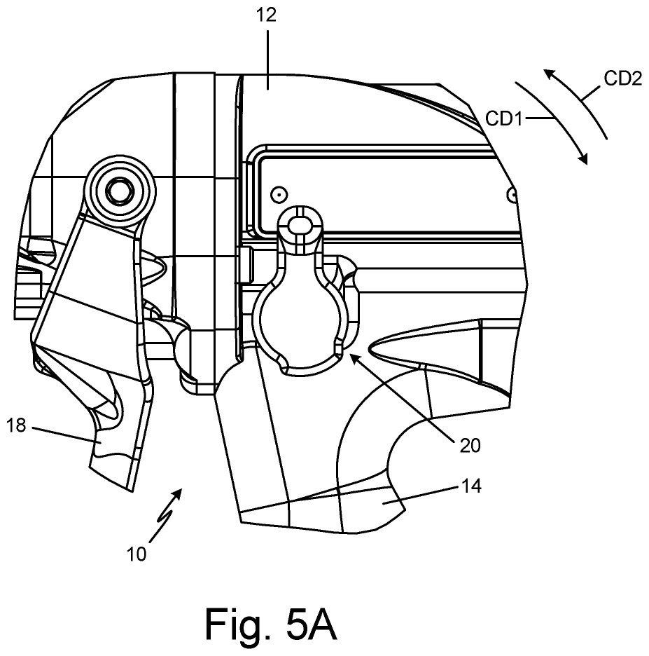

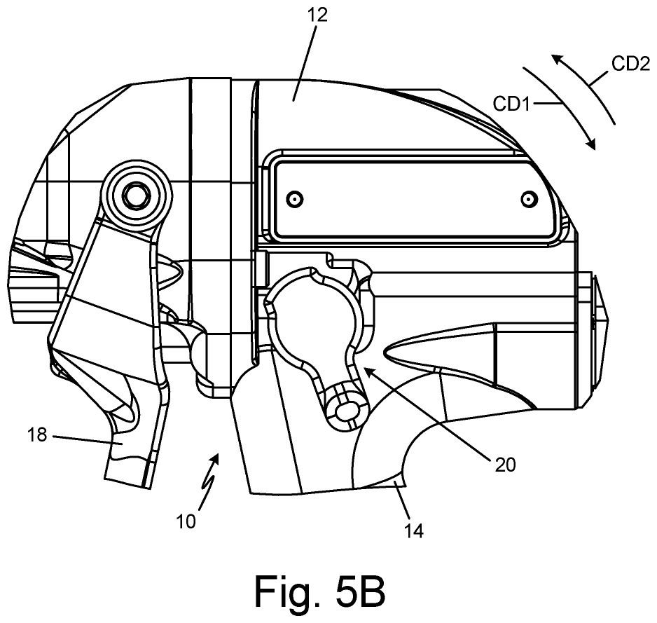

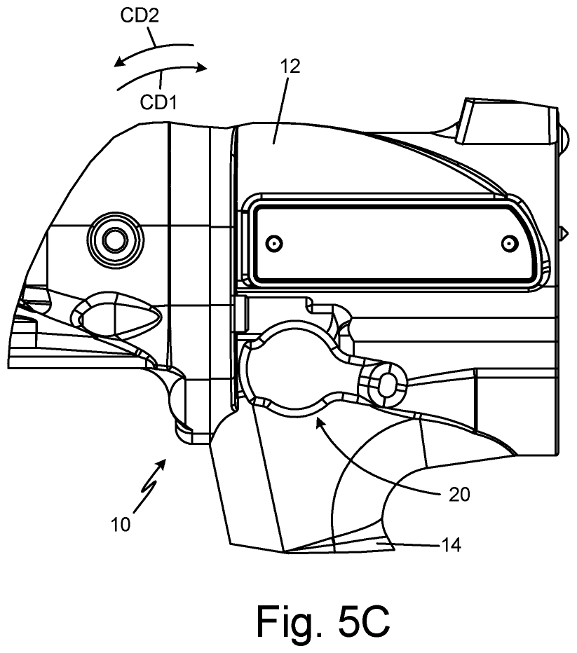

Fan air control assembly 20 is actuatable between a first position (FIG. 5B) associated with a minimum flow state (e.g., no flow) of the fan air portion and a second position (FIG. 5C) associated with a maximum flow state of the fan air portion. In some examples, fan air control assembly 20 can be placed at any desired position intermediate the first position and the second position to provide an intermediate flow between the maximum and minimum flows. Fan air control assembly 20 can thereby feather the flow of the fan air portion through sprayer.

Fan lever 28 interfaces with valve assembly 40 to control valve assembly 40 between fully closed and fully open states. Lever cap 30 connects to adaptor 32 to form fan lever 28. Lever cap 30 and adaptor 32 are configured to be fixed together to concurrently rotate on valve axis B. Lever arm 36 projects from lever body 34. In the example shown, lever arm 36 extends radially outward relative to lever body 34. Lever arm 36 is a projection that facilitates the user interfacing with fan lever 28 and exerting torque on fan lever 28 to cause rotation of fan lever 28 about axis B. Knob 48 is formed at a distal end of lever arm 36 opposite lever body 34. Knob 48 is an axial projection on lever arm 36 (relative to axis B) that provides an enlarged surface area at the distal end of lever arm 36. The larger surface area of knob 48 makes it easier for a user to interface with an manipulate fan lever 28.

Receiving chamber 44 is formed in the lever body 34. In the example shown, receiving chamber 44 extends partially, not fully, through lever body 34 along axis B. Receiving chamber 44 is disposed on axis B such that axis B extends through receiving chamber 44. In the example shown, chamber flats 46 are formed on the walls of lever body 34 defining receiving chamber 44. Chamber flats 46 are variations in the smoothly contoured surface defining receiving chamber 44. Chamber flats 46 can be considered to form contoured wall portions of receiving chamber 44. Chamber flats 46 are configured to interface with a portion of adaptor 32 (e.g., with adaptor projection 52) to rotationally lock lever cap 30 and adaptor 32 together. More specifically, the chamber flats 46 are configured to interface with adaptor flat 66 formed on adaptor 32 to form the rotation lock. The chamber flats 46 form a rotational lock interface within receiving chamber 44.

Fixture opening 42 extends through lever cap 30 between an outer radial edge (relative to valve axis B) and the interior of receiving chamber 44. Fixture opening 42 is configured to receive a fastener, such as lever set screw 118, that is configured to pass through fixture opening 42 and engage with adaptor 32 to fix adaptor 32 to lever cap 30. In some examples, fixture opening 42 can be a threaded opening configured to receive lever set screw 118.

Depression 116 is formed on an inner axial side of lever arm 36 (relative to axis B) oriented towards sprayer 10. Depression 116 provides access to apply a fastener, such as an additional valve screw 120, through lever body 34. For example, a second fixture opening 42 can be formed through lever body 34 from within depression 116, such as in examples where lever cap 30 and adaptor 32 are integrally formed and directly connected to valve member 74. The fastener applied through depression 116 can directly interface with valve member 74 in such examples.

Adaptor 32 is configured to interface with lever cap 30 to be actuated about valve axis B by lever cap 30. Adaptor 32 is further configured to interface with valve member 74 to actuate valve member 74 and thereby control the flow of the fan air. Adaptor body forms a first portion of adaptor 32 and adaptor projection 52 forms a second portion of the adaptor 32. Adaptor body 50 and adaptor projection 52 can be disposed coaxially on valve axis B.

Adaptor projection 52 has a smaller width than adaptor body 50. Adaptor projection 52 extends in a first axial direction AD1 from adaptor body 50, which first axial direction AD1 is towards lever cap 30, and away from the gun body 12 with fan air control assembly 20 mounted to sprayer 10. Adaptor projection 52 extends into and is received by receiving chamber 44 of lever cap 30. Adaptor flat 66 are formed on the exterior of adaptor projection 52. Adaptor flat 66 are configured to interface with chamber flats 46 to form the rotation lock between lever cap 30 and adaptor 32. The rotation lock prevents relative rotation about lever axis B. Lever set screw 118 is configured to interface with the exterior of adaptor projection 52 to fix adaptor 32 to lever cap 30 axially relative to valve axis B. In the example shown, lever set screw 118 extends through a chamber flat 46 and interfaces with a adaptor flat 66 formed on adaptor projection 52.

In the example shown, adaptor body 50 includes a cylindrical wall projecting axially away from adaptor projection 52 and axially in second axial direction AD2 towards gun body 12 and away from lever cap 30. Adaptor body 50 is disposed outside of receiving chamber 44. A lever wall 54 is disposed at the interface between adaptor projection 52 and adaptor body 50. The exterior surface of lever wall 54 (oriented in first axial direction AD1) extends radially, relative to axis B, between the outer edge of adaptor projection 52 and the outer edge of adaptor body 50. The exterior surface of the lever wall 54 axially opposes an axially oriented edge (oriented in second axial direction AD2) of the lever body 34 with adaptor 32 mounted to lever cap 30. The exterior surface of the lever wall 54 extends fully about adaptor projection 52.

Adaptor 32 defines valve chamber 58. Valve chamber 58 is formed in an interior of adaptor 32. Portions of valve assembly 40 are disposed within valve chamber 58 during operation. In the example shown, valve chamber 58 includes outer chamber 60 extending into adaptor projection 52 and inner chamber 62 at least partially defined by adaptor body Outer chamber 60 has a smaller diameter than inner chamber 62. Outer chamber 60 and inner chamber 62 are disposed coaxially on valve axis B. In the example shown, receiving chamber 44, outer chamber 60, and inner chamber 62 are disposed coaxially on valve axis B.

An inner side of the lever wall 54 is oriented into valve chamber 58. In the example shown, lever wall 54 is oriented axially into inner chamber 62 and is disposed at an opposite axial end of inner chamber 62 from the adaptor opening 64 disposed at the open axial end of valve chamber 58. Portions of valve assembly 40 extend into valve chamber 58 through adaptor opening 64. Adaptor 32 is formed such that outer chamber 60 extends in a first axial direction AD1 along the valve axis B from lever wall 54 and inner chamber 62 extends in a second axial direction AD2 relative to the valve axis B from lever wall 54. The first axial direction AD1 is an opposite direction from the second axial direction AD2.

Lever grooves 56 are formed within adaptor 32. Lever grooves 56 are formed at the distal end of inner chamber 62 opposite adaptor opening 64. In the example shown, lever grooves 56 are formed on lever wall 54 and disposed within valve chamber 58. More specifically, lever grooves 56 are formed on the interior side of lever wall 54. Fan lever 28 includes a plurality of the lever grooves 56 disposed about valve axis B. An array of the lever grooves 56 is formed circumferentially around valve axis B. The lever grooves 56 can be formed tangentially to one or more circles centered on the valve axis B. In the example shown, each lever groove 56 is formed tangentially to the same common circle centered on valve axis B. Lever grooves 56 are formed as depressions in the lever wall 54. It is understood that lever grooves 56 can be integrally formed during manufacturing of fan lever 28 (e.g., by casting, molding, additive manufacturing, etc.) or formed after production of fan lever 28 such as by removal of material (e.g., machining) While fan lever 28 is shown as including a set of four lever grooves 56, it is understood that fan lever 28 can include any desired number of lever grooves 56, including more or less than the four lever grooves 56 shown. Lever grooves 56 facilitate mounting of fan lever 28 to spring 38 in multiple orientations to position fan lever 28 in desired orientations during operation.

Fixture openings 68 extend through adaptor projection 52 to outer chamber 60. Fixture openings 68 are configured to receive fasteners that pass through fixture openings 68 and engage with valve member 74 to fix valve member 74 and adaptor 32 together for simultaneous rotation. In some examples, fixture openings 68 can be threaded openings configured to receive valve set screws 120. While adaptor 32 is shown as including multiple fixture openings 68 (two in the example shown), such that fan lever 28 is fixed to valve member 74 by multiple valve set screws 120, it is understood that adaptor 32 can include a single fixture opening 68 or more than two fixture openings 68. In the example shown, the fixture openings 68 are disposed within receiving chamber 44 with lever cap 30 mounted to adaptor 32. Disposing fixture openings 68 within receiving chamber 44 prevents valve set screws 120 from backing out during operation and protects the screw interfaces from environmental contaminants.

Valve assembly 40 is removably mountable to sprayer 10. Valve assembly 40 extends at least partially into sprayer 10 and projects axially outwards from sprayer 10 along valve axis B to interface with fan lever 28. Valve assembly 40 controls the flow fan air through gun body 12. A portion of valve assembly 40 extends into the fan air path to directly interface with the fan air flowing within sprayer 10.

Valve mount 72 is configured to interface with and connect to gun body 12 to mount valve assembly 40 to sprayer 10. Valve mount 72 can alternatively be referred to as a valve nut. Shaft bore 84 extends axially through valve mount 72. In the example shown, shaft bore 84 is disposed coaxially with receiving chamber 44, outer chamber 60, and inner chamber 62. Shaft bore 84 is open at both axial ends of shaft bore 84. First axial end 92 of shaft bore 84 is oriented in first axial direction AD1 and away from the fan lever 28 and the second axial end 94 of shaft bore 84 is oriented in second axial direction AD2 and towards fan lever 28.

Mount body 80 is configured to interface with a portion of gun body 12 to fix valve assembly 40 to sprayer 10. For example, mount body 80 can include exterior threading formed thereon that interfaces with interior threading in a mounting bore formed in the gun body 12. The interface between mount body 80 and gun body 12 (e.g., by the interfaced threading) fixes valve assembly 40, and thus fan air control assembly 20, to the sprayer 10.

Flow control body 78 extends in the second axial direction AD2 from mount body Flow control body 78 is configured to be disposed within gun body 12. In the example shown, flow control body 78 is cylindrical and extends in the second axial direction AD2 from mount body 80. The distal end of flow control body 78 can, in some examples, interface with a portion of gun body 12 to form a seal within gun body 12, as discussed in more detail below with regard to FIG. 3. Flow openings 86 extend through the flow control body 78 between the exterior of flow control body 78 and shaft bore 84. Flow openings 86 provide passages for compressed air to flow between a first chamber on an exterior of flow control body 78 and a second chamber on an interior of flow control body 78. Second axial end 94 of shaft bore 84 provides a second opening through which the fan air can flow. For example, second axial end 94 can be one of an inlet and an outlet of the valve of fan air control assembly 20 and flow openings 86 can be the other of the inlet and the outlet of the valve of fan air control assembly 20. In the example shown, second axial end 94 forms the inlet and flow openings 86 form the outlet.

Position body 82 is disposed on an opposite axial side of mount body 80 from flow control body 78. In the example shown, position body 82 extends in first axial direction AD1 from mount body 80. In the example shown, the projecting position body 82 is an arcuate body extending partially about valve axis B. Position body 82 extends between circumferential ends 122. Rotation notch 90 is disposed circumferentially between the circumferential ends 122 and defined by the circumferential ends 122. Rotation notch 90 is a depression formed by a break in an annular area of position body 82 such that position body 82 is arcuate and does not extend fully about axis B, in the example shown. In some examples, rotation notch 90 extends over an angular extent (e.g., circumferentially about valve axis B) less than or equal to 90-degrees. In some examples, rotation notch 90 extends over an angular extent less than or equal to 60-degrees. Valve member 74 can be rotated a quarter turn or less between the fully closed and fully open states. In some examples, valve member 74 can be rotated a fifth of a turn or less between the fully closed and fully open states. The small angular turn between fully open and fully closed provides easy actuation to the user and allows for precise control while simultaneously manipulating and spraying with sprayer 10.

Valve grooves 88 are formed on valve mount 72. In the example shown, valve grooves 88 are formed on an axial end of valve mount 72. More specifically, valve grooves 88 are formed on an axial end of position body 82 oriented in first axial direction AD1. Valve grooves 88 are formed on the axial end of position body 82. Valve grooves 88 are formed on the exterior of valve mount 72. Valve grooves 88 are disposed at the distal end of valve mount 72 in the first axial direction AD1. Valve mount 72 includes a plurality of the valve grooves 88 disposed about valve axis B. An array of the valve grooves 88 is formed at least partially around valve axis B. In the example shown, valve grooves 88 form an arcuate array of grooves about valve axis B. The valve grooves 88 can be formed tangentially to one or more circles centered on the valve axis B. In the example shown, each valve groove 88 is formed tangentially to a common circle centered on valve axis B. Valve grooves 88 are formed as depressions in the axial end face of position body 82. It is understood that valve grooves 88 can be integrally formed during manufacturing of valve mount 72 (e.g., by casting, molding, additive manufacturing, etc.) or formed after production of valve mount 72 such as by removal of material (e.g., machining) While valve mount 72 is shown as including a set of five valve grooves 88, it is understood that valve mount 72 can include any desired number of valve grooves 88, including more or less than the five valve grooves 88 shown. The count of valve grooves 88 can be the same as or vary from (either more or less than) the count of lever grooves 56.

As shown, valve mount 72 includes tool interface surfaces 124 formed on the exterior of position body 82. The tool interface surfaces 124 facilitate mounting of valve member 74 to the sprayer 10. For example, mount body 80 can include threading and the user can torque valve mount 72 by a wrench (or other tool) interfacing with tool interface surfaces 124. As shown, some of the valve grooves 88 can have different lengths than other ones of the valve grooves 88.

Valve member 74 is elongate along valve axis B. Valve member 74 is configured to rotate on valve axis B between the open and closed states. Portions of valve member 74 are disposed within outer chamber 60, inner chamber 62, and shaft bore 84 with the components of fan air control assembly 20 assembled together. Shaft body 100 extends axially, relative to valve axis B, between connector 96 disposed at a first axial end of valve member 74 and flow controller 98 disposed at a second axial end of valve member 74.

Connector 96 of valve member 74 extends into outer chamber 60. Head 102 is disposed at the distal portion of the first axial end of valve member 74. Mount groove 104 is formed on valve member 74. Mount groove 104 is a radial depression, relative to valve axis B, extending into valve member 74. As such, valve member 74 has a smaller diameter at mount groove 104 than at head 102 or other portions of shaft body 100. Mount groove 104 can extend annularly about valve member 74. Mount groove 104 is configured to be radially aligned with fixture openings 68 with connector 96 disposed in the outer chamber 60. The radial alignment facilitates valve set screws 120 extending into mount groove 104 to fix valve member 74 and fan lever 28 together. Head 102 having a larger diameter than the portion of valve member 74 defining the radially inner side of mount groove 104 facilitates the head 102 axially interfacing with lever set screws 118 to prevent fan lever 28 from being pulled axially off of valve member 74 along valve axis B.

Rod opening 106 extends into shaft body 100. Rod opening 106 is configured to receive rotation limiter 114. Rotation limiter 114 projects radially from valve member 74 relative to valve axis B. Rotation limiter 114 is a projection disposed in rotation notch 90 during operation. The circumferential ends 122 interface with rotation limiter 114 to limit rotational movement of valve member 74 on valve axis B. Rotation limiter 114 can be of any desired configuration for interfacing with valve mount 72 and limiting rotation of valve member 74. For example, rotation limiter 114 can be a dowel, rod, shaft, bar, screw, bolt, or other type of projection. Rotation limiter 114 can be removably connected to valve member 74 to facilitate assembly and disassembly of fan air control assembly 20. In some examples, rotation limiter 114 can be configured to mount to valve member 74 by interfaced threading on rotation limiter 114 and in rod opening 106. It is understood that, in some examples, rotation limiter 114 can be integrally formed as part of valve member 74.

Valve member 74 is rotationally limited about valve axis B such that valve member 74 does not rotate fully, 360-degrees on valve axis B. For example, valve member 74 can be limited to rotating up to 90-degrees, up to 60-degrees, or less during operation. Interface 77 limits rotation of valve member 74 about valve axis B. In the example shown, interface 77 is formed between valve member 74 and valve mount 72. More specifically, interface 77 is formed by rotation limiter 114 being disposed within rotation notch 90 such that rotation notch 90 defines the rotational travel limits of rotation limiter 114 and thus of valve member 74.

Rotation notch 90 is sized such that valve assembly 40 is in the maximum flow state with rotation limiter 114 interfacing with a first circumferential end 122 defining rotation notch 90 and such that valve assembly 40 is in the minimum flow state with rotation limiter 114 interfacing with the other, second circumferential end 122 of rotation notch 90. In the example shown, rotation notch 90 is sized such that valve assembly 40 is fully open with rotation limiter 114 at one circumferential end 122 defining rotation notch 90 and such that valve assembly is fully closed with rotation limiter 114 at the other circumferential end 122 defining rotation notch 90.

Seal groove 108 is formed on valve member 74 axially between flow controller 98 and connector 96. Valve seal 76 is mounted on valve member 74 and received by seal groove 108. Valve seal 76 is disposed within shaft bore 84 and interfaces with a surface of valve mount 72 within shaft bore 84. In the example shown, valve seal 76 is disposed within a portion of shaft bore 84 defined by mount body 80. Valve seal 76 can interface with and seal against the portion of mount body 80 defining shaft bore 84. The interface between valve seal 76 and valve mount 72 forms an airtight seal to prevent the fan air from leaking out of fan air control assembly 20. Valve seal 76 can be an elastomer seal. Valve seal 76 can be an O-ring, among other options.

Flow controller 98 of valve member 74 forms an actuatable flow control component of valve assembly 40. In the example shown, flow controller 98 is a barrel having openings radially therethrough relative to valve axis B. Flow controller 98 is disposed within shaft bore 84 with valve member 74 mounted to valve mount 72. More specifically, flow controller 98 is disposed within the portion of shaft bore 84 defined by flow control body 78. Flow controller 98 interacts with flow control body 78 to control the flow of the fan air through valve assembly 40. In the example shown, flow controller 98 directly interfaces with flow control body 78 to form a sealing interface therebetween. The interface between the outer surface of flow controller 98 and the inner surface of flow control body 78 seals the flowpath through valve assembly 40 when valve assembly 40 is closed. The axial end of flow controller 98 oriented in second axial direction AD2 is open to allow fan air to flow into an interior of flow controller 98 through second axial end 94 of shaft bore 84. Flow controller 98 forms a barrel valve member in the example shown.

Flow blockers 112 are formed as arcuate projections at flow controller 98. Flow blockers 112 extend in second axial direction AD2. Flow passages 110 are formed in flow controller 98 between adjacent ones of the flow blockers 112. Flow passages 110 are axially elongate slots in the example shown. Valve member 74 controls the flow of fan air flow through valve assembly 40 based on relative positions of flow controller 98 and flow control body 78. While valve member 74 is shown as including multiple flow blockers 112 and flow passages 110, it is understood that some examples of valve member 74 include one flow blocker 112 and one associated flow passage 110.

Valve assembly 40 is open such that fan air can flow through valve assembly 40 when flow passages 110 are radially aligned with flow openings 86 (e.g., such that a radial line from valve axis B extends through both the flow passage 110 and flow opening 86). Valve assembly 40 is closed such that fan air cannot flow through valve assembly 40 when flow blockers 112 are radially aligned with flow openings 86. In some examples, flow passages 110 are wider (circumferentially about valve axis B) than flow openings 86. As such, valve member 74 can be positioned such that no portion of flow blocker 112 is radially aligned with flow openings 86 with valve assembly 40 in the open state. In such an open state, the fan air control valve can be considered to be fully open. Valve member 74 can be positioned at intermediate flow positions relative to valve mount 72. With valve member 74 in the intermediate positions, the flow openings 86 are partially aligned with flow passages 110 and partially aligned with flow blockers 112. As such, flow passages 110 and flow blockers 112 can each be partially radially misaligned with the flow openings 86 and partially radially aligned with the flow openings 86 in the intermediate flow positions.

In some examples, valve member 74 is configured to maintain any desired flow position relative to valve mount 72 upon release of fan lever 28 by the user. For example, the interface between valve seal 76 and valve mount 72 can prevent rotation of valve member 74 on valve axis B unless sufficient force is applied by the user. The interface can resist rotation due to gravity acting on lever arm 36 and due to forces generated by the user moving sprayer 10 during operation. The user can thereby feather the fan air to a desired flow rate during spraying and can release fan lever 28 to maintain the fan air at the desired flow rate. The sprayer 10 is thereby easily and quickly configured to generate the desired spray pattern and maintain the desired spray pattern.

In the example shown, spring 38 is disposed axially between portions of fan lever 28 and valve assembly 40. Spring 38, shaft bore 84, and valve chamber 58 are disposed coaxially. In the example shown, spring 38 is a torsion spring configured to exert torque on fan lever 28 to drive rotation about valve axis B. Spring 38 is configured to interface with fan lever 28 and with valve assembly 40 to automatically return the valve assembly to a base state (associated with one of the minimum flow position and the maximum flow position) upon the release of fan lever 28. In the example shown, the base state is associated with the maximum fan air state such that the fan lever 28 is actuated from the base state to reduce the fan air flow through gun body 12. Spring 38 returns valve assembly to the base state upon release of the fan lever 28.

Spring 38 interfaces with fan lever 28 at lever grooves 56 and with valve assembly at valve grooves 88. A first spring leg 70 of spring 38 is received within a lever groove 56. A second spring leg 70 is received within a valve groove 88. The depressions forming the lever groove 56 and valve groove 88 receive the spring legs 70. Valve mount 72 is fixed to gun body 12 to prevent rotation of valve mount 72 on valve axis B. Spring 38 braces on valve mount 72 and exerts a circumferential force on fan lever 28 to bias fan lever 28 in a rotational direction about valve axis B. The multiple lever grooves 56 and multiple valve grooves 88 facilitate positioning fan lever 28 in any desired orientation about valve axis B while mounting to valve assembly 40. The multiple valve grooves 88 facilitate mounting spring 38 to valve mount 72 in multiple orientations to facilitate mounting of fan lever 28 in the desired orientation regardless of the final orientation of valve mount 72, which orientation can vary due to a threaded interface connecting valve member 74 to gun body 12. The multiple lever grooves 56 facilitate mounting of fan lever 28 to spring 38 in a desired orientation for comfortable and ergonomic actuation by the user. For example, the user can alter the orientation that the lever arm 36 extends in away from valve axis B by seating the spring leg 70 in different ones of the lever grooves 56 and/or different ones of valve grooves 88. Fan lever is pretensioned with the spring 38 to keep the valve open in the example shown. The multiple lever grooves 56 and valve grooves 88 facilitate the user setting the spring 38 at a desired tension for operation. For example, a larger rotation between the starting (FIG. 5A) and actuated positions (FIG. 5B) provides greater tension while a smaller rotation between the starting and actuated positions provides less tension.

Fan valve assembly 40 controls the flow of fan air during operation of a sprayer. During assembly, valve member 74 is passed through shaft bore 84 in first axial direction AD1. In some examples, a portion of valve member 74 (e.g., adjacent to seal groove 108) can have a larger diameter than a portion of the shaft bore 84 to limit movement of valve member 74 in first axial direction AD1. Valve member 74 can be rotated about valve axis B until rod opening 106 is aligned within rotation notch 90. Rotation limiter 114 is inserted into rod opening 106 and fixed to valve member 74. Valve member 74 is thereby axially fixed relative to valve mount 72 by rotation limiter 114 extending axially over a portion of valve mount 72 preventing movement in the second axial direction AD2 and by the varied diameter portions of valve member 74 and valve mount 72 within shaft bore 84 preventing movement in the first axial direction AD1.

Spring 38 is inserted over valve member 74 and positioned on valve mount 72 such that a spring leg 70 is disposed within a valve groove 88. In some examples, spring 38 is positioned such that the free spring leg 70 (the spring leg 70 not within the valve groove 88) is oriented generally vertically or generally horizontally. Such a positioning facilitates ergonomic positioning of fan lever 28 for use during operation.

Fan lever 28 is shifted axially in second axial direction AD2 and onto valve assembly 40. More specifically, fan lever 28 is shifted onto valve assembly 40 such that connector 96 of valve member 74 is disposed within outer chamber 60. Fan lever 28 is positioned on valve assembly 40 such that the free spring leg 70 is disposed within one of lever grooves 56. Adaptor 32 is connected to valve member 74 by valve set screw 120 extending through fixture openings 68 and into mount groove 104. Lever cap 30 is mounted to adaptor 32 by lever set screw 118 extending through fixture opening 42 and interfacing with adaptor projection 52.

Fan air control assembly 20 provides significant advantages. Fan air control assembly 20 facilitates active fan air control while spraying. Different spray patterns can be generated during a single spray pass by actuating fan air control assembly 20. The user can actively feather the air flow and alter the spray pattern during spraying, allowing for closer spraying at edges and a more uniform pattern. Fan air control assembly 20 thereby reduces job time, reduces material use and waste, and increases spray operation efficiency. Fan air control assembly 20 allows for personal adjustment of the lever for individual users. The valve grooves 88 and lever grooves 56 negate the effect of the threaded connection seating variance of the valve mount 72.

FIG. 3 is a cross-sectional view taken along line 3-3 in FIG. 1 showing fan air control assembly 20 mounted to sprayer 10. Fan air control assembly 20 is mounted to sprayer 10 at mount bore 138. Mount bore 138 is formed within gun body 12 and intersects with the fan air flowpath through gun body 12.

Valve assembly 40 is directly mounted to gun body 12 by valve mount 72 interfacing with gun body 12 within mount bore 138. In the example shown, valve mount 72 is connected to gun body 12 by interfaced threading. A distal end of flow control body 78 interfaces with gun body 12 within mount bore 138. In the example shown, annular face 126 of flow control body 78 directly interfaces with gun body 12 to form a sealed interface. The sealed interface prevents undesired flow of fan air between inlet 128 and outlet 130. Annular face 126 is a sloped face configured to interface with a sloped surface within mount bore 138. The annular face 126 and portion of mount bore 138 are sloped in second axial direction AD2 and radially inward towards valve axis B.

Annular chamber 132 is formed about the exterior of flow controller 98. Annular chamber 132 is defined between flow controller 98 and the portion of gun body 12 defining mount bore 138. Annular chamber 132 is a portion of mount bore having a larger diameter than the outer diameter of flow controller 98. Annular chamber 132 negates the effect of the threaded connection seating variance of the valve mount 72 because flow openings 86 will be positioned to be fluidly connected with annular chamber 132 regardless of the rotational position of valve mount 72 about valve axis B.

With valve member 74 in an open state, such that flow passages 110 are at least partially aligned with flow openings 86, the fan air can flow from inlet 128, through second axial end 94, through the flow passages 110 and flow openings 86, and downstream to outlet 130. With valve member 74 in a closed state, such that flow passages 110 are misaligned with flow openings 86, the fan air can flow into valve assembly 40 but is prevented from flowing to outlet 130 by flow blockers 112 being aligned with flow openings 86 to fully cover flow openings 86.

Shoulder 134 is formed on a portion of valve member 74 disposed axially between seal groove 108 and head 102. In the example shown, shoulder 134 is formed axially between seal groove 108 and rod opening 106, such that shoulder 134 is disposed axially between seal groove 108 and rotation limiter 114. Brace 136 is formed by a portion of valve mount 72 defining shaft bore 84. In the example shown, brace 136 is an annular narrowing of the shaft bore 84. More specifically, shaft bore 84 has a first diameter portion between first axial end 92 and brace 136 and shaft bore 84 has a second, larger diameter portion between brace 136 and the second axial end 94. The interface between shoulder 134 and brace 136 limits axial movement of valve member 74 in first axial direction AD1 relative to valve mount 72.

Adaptor body 50 extends over and at least partially encloses the portion of valve mount 72 disposed outside of gun body 12. Adaptor body 50 receives position body 82 within outer chamber 60 in the example shown. Adaptor body 50 receiving position body 82 prevents contaminant migration into valve assembly 40. The adaptor body 50 extending over position body 82 creates an elongate, labyrinth path between the environment surrounding fan air control assembly 20 and the flow controller (e.g., formed by flow control body 78 and flow controller 98) of the valve assembly 40. Any contaminants would need to flow between adaptor body 50 and position body 82 and turn 180-degrees to flow between position body 82 and shaft body 100 before reaching valve seal 76.

Adaptor 32 receiving and extending over position body 82 provides a robust fan air control assembly 20. Adaptor 32 extending over position body 82 prevents undesired off center forces from being applied to valve member 74 as the overlap between adaptor 32 and position body 82 can maintain concentricity on axis B. The overlap maintains concentricity between fan lever 28 and valve member 74 and thus maintains concentricity between valve member 74 and valve mount 72, preventing undesired side loading that can cause undesired wear and premature failure of components.

Fan air control assembly 20 can be retrofit on existing sprayers 10. Sprayers that have fan air include a valve to control the flow and thus the resultant spray pattern. The valves are typically needle valves that are threaded into or out of engagement with a seat to vary the flow of the fan air portion. Fan air control assembly 20 is configured to mount to the same threading (e.g., within mount bore 138) as the previous fan valve. The sprayer 10 requires no other modification to change the configuration to the quick control provided by fan air control assembly 20.

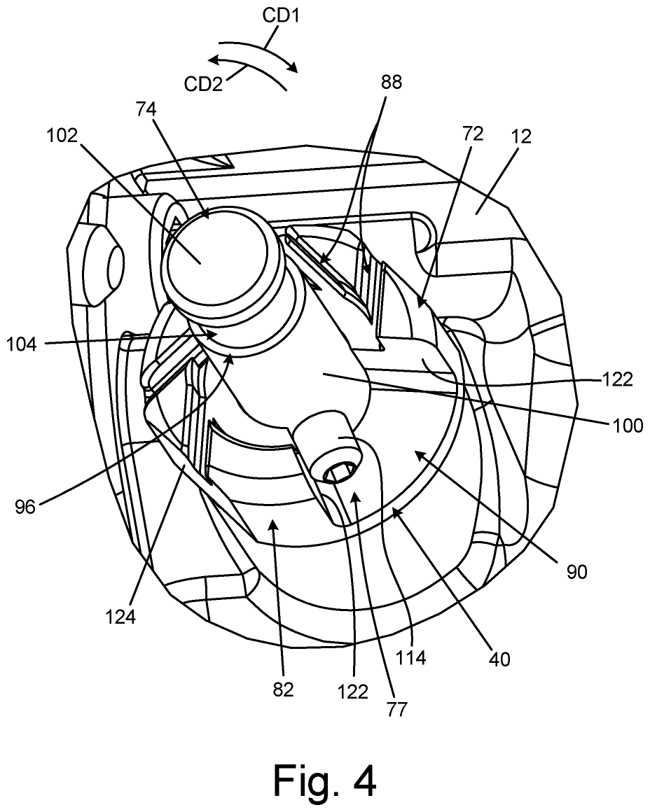

FIG. 4 is an isometric view showing valve assembly 40 mounted to sprayer 10. FIG. 5A is an elevation view showing the fan lever 28 in a first position. FIG. 5B is an elevation view showing the fan lever 28 in a second position associated with an actuated state of fan air control assembly 20. FIG. 5C is an elevation view showing the fan lever E in a third position associated with a base state of fan air control assembly 20.

Valve assembly 40 is mounted to gun body 12 in the assembled state. Valve member 40 is passed through shaft bore 84 and shoulder 134 interfaces with brace 136. Rod opening 106 is aligned with rotation notch 90 and rotation limiter 114 is connected to valve member 74. Rotation limiter 114 is thereby disposed in rotation notch 90. Valve member 74 extends through shaft bore 84 with rotation limiter 114 disposed in rotation notch 90. Valve member 74 is thereby axially secured to valve mount 72 and is rotationally limited by interface 77 between rotation limiter 114 and rotation notch 90.

Mount body 80 is inserted into the valve mounting bore 138 of the sprayer 10 and interfaces with a portion of the gun body 12 to secure valve assembly to sprayer 10 (e.g., by interfaced threading). Mount body 80 can be rotated about valve axis B to connect to and disconnect from gun body 12, such as by interfaced threading.

Spring 38 is mounted to valve assembly 40. Spring 38 is shifted axially along valve axis B such that valve member 74 extends through the coil of spring 38. A first spring arm 70 of spring 38 is placed in a valve groove 88. As discussed above, the multiple valve grooves 88 facilitate mounting spring 38 to mount body 80 in a desired orientation (e.g., so spring legs 70 extend in desired directions) regardless of the final orientation of valve mount 72 about valve axis B, which can vary (e.g., due to a threaded mounting interface).

Valve member 74 is rotated to a desired starting position associated with one of the maximum and minimum fan air flow states. Rotation limiter 114 is at an extreme limit of rotational movement and interfaces with one of the circumferential ends 122 defining rotation notch 90 when in the starting position. In the example discussed, valve member 74 is placed in a minimum flow position during mounting, as shown in FIG. 4. More specifically, valve member 74 is positioned such that valve assembly 40 is fully closed with valve member 74 in the starting position.

Fan lever 28 is interfaced with the mounted valve assembly 40. Fan lever 28 is initially interfaced with the valve assembly 40 with fan lever 28 in a mounting orientation (FIG. 5A) that differs from one or both of the maximum flow orientation (e.g, the third position shown in FIG. 5C) and the minimum flow orientation (e.g., the second position shown in FIG. 5B). The positions and orientations of fan lever 28 about valve axis B associated with the actuated state and base state are independent of the orientation of valve mount 72 when mounted to sprayer 10. For example, the rotation notch 90 can be oriented in any radial direction relative to valve axis B and the positions associated with the actuated and base states can still be those shown in FIGS. 5B and 5C. The independent orienting of fan lever 28 is due to the multiple valve grooves 88 and lever grooves 56 facilitating mounting in various orientations and due to spring 38 facilitating any desired relative rotational positioning between fan lever 28 and valve mount 72.

Fan lever 28 is placed over the portion of the valve member 74 projecting from the valve mount 72. Fan lever 28 interfaces with spring 38 and thus interfaces with valve mount 72 via spring 38. A second spring leg 70 is disposed in a lever groove 56 of fan lever 28. As best seen in FIGS. 2A and 2B, lever grooves 56 can be wider than valve grooves 88 to facilitate ease of mounting because the interface between lever grooves 56 and the second spring arm 70 cannot be seen during the mounting procedure. The narrower valve groove 88 reduces play during rotation of fan lever 28 providing quick response and tensile feedback to the user.

When fan lever 28 is initially disposed on valve assembly 40 a portion of valve member 74 is disposed within outer chamber 60 but valve member 74 is rotationally disconnected from fan lever 28. Fan lever 28 is connected to valve assembly 40 by spring 38 but is not directly connected to components of valve assembly 40. Rotating fan lever 28 about valve axis B does not concurrently rotate valve member 74 because fan lever 28 and valve member 74 are disconnected.

Fan lever 28 is rotated in a first circumferential direction CD1 (clockwise in the views of FIGS. 5A-5C) from the mounting orientation to a desired orientation associated with the actuated state (FIG. 5B). In the example shown, the desired orientation is with fan lever 28 disposed at the second position shown in FIG. 5B. Fan lever 28 is rotated from the mounting orientation to the desired orientation in the same direction as the rotational direction of the starting position of valve member 74. Fan lever 28 is thereby rotated in a first rotational direction (e.g., circumferential direction CD1) while valve member 74 is already at the rotational limit in the first rotational direction for valve member 74 (e.g., due to the interface between rotation limiter 114 and rotation notch 90). In the example shown, rotation limiter 114 is disposed at the first circumferential end of rotation notch 90 in circumferential direction CD1, so fan lever 28 is also rotated clockwise in circumferential direction CD1 from the mounting orientation to the desired orientation. The common rotational directions facilitate spring 38 returning valve member 74 to the base state once valve member 74 is rotationally locked to fan lever 28.

Spring 38 resists rotation of fan lever 28 in the first circumferential direction CD1 and biases fan lever 28 in a second circumferential direction CD2 (counterclockwise in the views of FIGS. 5A-5C) opposite the first circumferential direction CD1. Fan lever 28 is rotated on valve axis B to a desired position associated with the actuated state (FIG. 5B), which is the position of fan lever 28 when actuated by the user during operation. In the example shown, the actuated state is associated with the minimum flow state. It is understood that, in some examples, the actuated state can be associated with the maximum flow state. The position associated with the actuated state can be any desired position that is comfortable for the user.

Fan lever 28 is fixed to valve member 74 when in the desired position associated with the actuated state. In the example shown, lever cap 30 can be pulled in the first axial direction AD1 off of adaptor 32 while holding adaptor 32 to prevent spring 38 from rotating adaptor 32 off of the desired orientation associated with the actuated state. Adaptor 32 is then rotationally fixed to valve member 74 while adaptor 32 is maintained in the position associated with the actuated state. For example, the valve set screws 120 can be inserted through fixture openings 68 to interface with valve member 74 at mount groove 104. Adaptor 32 and valve member 74 are thus rotationally fixed together for simultaneous rotation.

Adaptor 32 can be released and spring 38 causes adaptor 32 to rotate back in the second circumferential direction CD2 to an orientation associated with the base state (FIG. 5C), which is the position of fan lever 28 during operation when fan lever 28 is not actuated by the user. In the example shown, the base state is associated with the maximum flow state. It is understood that, in some examples, the base state can be associated with the minimum flow state. The interface 77 limits rotation in the second circumferential direction CD2 to maintain valve assembly 40 in the base state.

Rotation limiter 114 and rotation notch 90 limit rotation of valve member 74, and thus of fan lever 28, in both circumferential directions CD1, CD2. In the example shown, rotation limiter 114 limits rotation of valve member 74, and thus fan lever 28, in second circumferential direction CD2 relative to the actuated state. Rotation limiter 114 engages one of the circumferential ends 122 of rotation notch 90 to limit rotation back in the second circumferential direction CD2. Spring 38 thereby drives valve member 74 relative to valve mount 72 from the position associated with the actuated state (FIG. 5B) to the position associated with the base state (FIG. 5C). Lever cap 30 is placed over adaptor 32 and secured to adaptor 32, such as by lever screw 118. It is understood that, in some examples, lever cap 30 and adaptor 32 are formed as a single assembly such that lever cap 30 is connected to valve assembly 40 concurrently with adaptor 32 prior to spring 38 rotating valve member 74 to place valve assembly 40 in the base state.

During operation, fan air control assembly 20 controls flow of the fan air portion to air cap 16. Fan air control assembly 20 is normally in the base state (FIG. 5C) during spraying. The base state is associated with the maximum flow state in the example shown such that a maximum volume of fan air can normally flow through valve assembly 40 (e.g., from inlet 128 to outlet 130 through second axial end 94, flow passages 110, and flow openings 86) to interact with and shape the spray liquid emitted by sprayer 10. The user can actuate fan air control assembly 20 from the base state to the actuated state, and to any intermediate state therebetween, by pressing on lever arm 36 to cause rotation of fan lever 28, and thus of valve member 74, about valve axis B. In the example shown, the user depresses fan lever 28 to cause rotation in circumferential direction CD1 when actuating from the base state.

Rotating valve member 74 at least partially aligns flow blockers 112 with flow passages 110, restricting flow of the fan air portion through valve assembly 40. In the example shown, the user can rotate fan lever 28, and thus valve member 74, to the actuated state (FIG. 5B) to fully shut off flow of the fan air. Flow blockers 112 fully cover flow openings 86 with fan air control assembly 20 in the actuated state, preventing flow of fan air through valve assembly 40. In the example shown, removing the actuating force from fan lever 28 (e.g., the user removing their thumb from lever arm 36) causes fan air control assembly 20 to automatically return to the base state. Spring 38 exerts a rotational force on fan lever 28, and thus on valve member 74 by fan lever 28, causing fan lever 28 and valve member 74 to rotate back to the base state upon removal of the actuating force. The user can feather the spray pattern during operation by pushing fan lever 28 between various positions intermediate the position associated with the actuated state and the position associated with the base state.

While fan air control assembly 20 is described as automatically returning to the base state, it is understood that examples of fan air control assembly 20 can be configured to remain in positions other than the position associated with the base state. For example, some examples of fan air control assembly 20 do not include spring 38. In such examples, the user can place fan valve assembly 40 in a position associated with the desired fan air flow rate and remove the actuating force from fan lever 28 without fan valve assembly 40 returning to the base state.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims. Also, while some options are shown, it is understood that those options do not need to be present, and some aspects could be removed or substituted.

1. A fan air control assembly for a spray gun configured to control flow of a fan air portion of compressed air to a spray end of the spray gun, the fan air portion configured to shape a spray pattern emitted by the spray gun, wherein the fan air control assembly comprises:
a fan lever;
a valve assembly operably connected to the fan lever, the valve assembly comprising:
a valve mount having a shaft bore extending axially therethrough along a valve axis, the valve mount comprising:
a mount body;
a position body extending from the mount body in a first axial direction; and
a flow control body extending from the mount body in a second axial direction, wherein at least one flow opening extends through the flow control body;
a valve member disposed at least partially within the shaft bore and fixed to the fan lever, wherein the valve member comprises:
a shaft body having a flow controller disposed within a flow control body of the valve mount, the flow controller including at least one flow blocker extending at least partially about the valve axis and at least one flow passage;
wherein the valve member is rotatable on the valve axis to actuate the valve assembly between a maximum flow state and a minimum flow state.

2. The fan air control assembly of claim 1, wherein the valve member further comprises:
a connector disposed at an opposite axial end of the valve member from the flow controller, the connector disposed within the fan lever and fixed to the fan lever.

3. The fan air control assembly of claim 2, wherein the connector includes a head having a first diameter and a mount groove spaced in the second axial direction from the head, and wherein the valve member is fixed to the fan lever by a first fastener extending through the fan lever and into the mount groove.

4. (canceled)

5. The fan air control assembly of claim 1, wherein the at least one flow blocker comprises an arcuate axial projection.

6. The fan air control assembly of claim 5, wherein the at least one flow blocker includes a plurality of flow blockers and wherein the at least one flow passage includes a plurality of flow passages.

7. (canceled)

8. (canceled)

9. The fan air control assembly of claim 1, wherein the valve member includes a seal groove formed on an exterior of the shaft body of the valve member, wherein a valve seal is disposed in the seal groove, and wherein the valve seal interfaces with a portion of the valve mount forming the shaft bore.

10. The fan air control assembly of claim 1, wherein the valve member includes a shoulder formed on the shaft body, the valve mount includes a brace formed within the shaft bore, and the brace interfaces with the shoulder to limit movement of the valve member in the first axial direction.

11. The fan air control assembly of claim 1, wherein the fan lever comprises:
an adaptor, wherein the first fastener extends through the adaptor to interface with the valve member; and
a lever cap, the lever cap receiving a portion of the adaptor and connected to the adaptor, the lever cap including a lever arm extending away from the valve axis.

12. (canceled)

13. The fan air control assembly of claim 11, wherein:
the lever cap defines a receiving chamber;
the adaptor includes a projection extending in the first axial direction and a cylindrical body extending in the second axial direction;
the projection extends into the receiving chamber; and
the adaptor is fixed to the lever cap by a second fastener extending through the lever cap and interfacing with the projection.

14. The fan air control assembly of claim 13, wherein the projection includes a first flat and the lever cap includes a second flat at least partially defining the receiving chamber, wherein the first flat interfaces with the second flat to prevent rotation of the lever cap relative to the adaptor.

15. The fan air control assembly of claim 1, further comprising:
a rotation notch is formed between a first circumferential end of the position body and a second circumferential end of the position body; and
a rotation limiter extending from a shaft body of the valve member and disposed within the rotation notch;
wherein the rotation notch limits movement of the rotation limiter in a first circumferential direction about the valve axis and in a second circumferential direction about the valve axis.

16. The fan air control assembly of claim 15, further comprising:
a spring interfacing with the fan lever and the valve mount, the spring configured to bias the fan lever in the second circumferential direction.

17. (canceled)

18. The fan air control assembly of claim 16, wherein:
the valve member includes at least one valve groove oriented in the first axial direction;
the fan lever includes at least one lever groove oriented in the second axial direction;
wherein a first spring arm of the spring is disposed in a first valve groove of the at least one valve groove and a second spring arm of the spring is disposed in a first lever groove of the at least one lever groove.

19. The fan air control assembly of claim 18, wherein the at least one valve groove includes a plurality of valve grooves formed on an end face of the position body.

20. The fan air control assembly of claim 18, wherein the at least one lever groove includes a plurality of lever grooves formed on the fan lever.

21. The fan air control assembly of claim 1, wherein:
the valve member includes a plurality of valve grooves oriented in the first axial direction;
the fan lever comprises:
an adaptor, wherein the first fastener extends through the adaptor to interface with the valve member, the adaptor defining a valve chamber that the valve member is at least partially disposed within;
a plurality of lever grooves formed on the adaptor and disposed within the valve chamber, the plurality of lever grooves oriented in the second axial direction;
a lever cap, the lever cap receiving a portion of the adaptor and connected to the adaptor, the lever cap including a lever arm extending away from the valve axis;
a spring is disposed between the valve mount and the fan lever; and
a first spring arm of the spring is disposed in a first valve groove of the plurality of valve grooves and a second spring arm of the spring is disposed in a first lever groove of the plurality of lever grooves.

22. The fan air control assembly of claim 1, wherein the at least one flow blocker is aligned with the flow opening to prevent any fan air flow therethrough with the valve assembly in the minimum flow state.

23. A fluid sprayer comprising:
a gun body having a handle extending therefrom;
a trigger extending from the gun body, the trigger configured to be actuated to control spraying by the fluid sprayer;
the fan air control assembly of claim 1 mounted to the gun body, the fan air control assembly extending into a fan air flowpath through the gun body to control flow of fan air through the gun body.

24. A method of controlling a fan air flow during spraying with a fluid sprayer, the method comprising:
grasping, with a first hand, a handle of the fluid sprayer;
actuating, with the first hand, a trigger of the fluid sprayer to cause the fluid sprayer to emit a liquid spray;
depressing, with the first hand, a fan lever projecting from a lateral side of a gun body of the fluid sprayer from a first position associated with a base state to a second position associated with an actuated state, the fan lever connected to a valve member to rotate the valve member on a valve axis thereby altering a flow of fan air to a spray end of the fluid sprayer; and
releasing, with the first hand, the fan lever.

25. (canceled)

26. A method of forming a fan air controller for a sprayer, the method comprising:
passing an axially elongate valve member through a shaft bore extending through a valve mount;
inserting a rotation limiter into a rod opening in the valve member, the rotation limiter disposed in a rotation notch formed in the valve mount, wherein the rotation notch limits travel of the rotation limiter in a first circumferential direction and a second circumferential direction;
connecting the valve mount to a spray gun by interfaced threading;
placing a spring on the valve mount such that a first spring arm of the spring is disposed in a valve groove formed on the valve mount;
placing a fan lever over a portion of the valve member projecting from the valve mount and such that a second spring arm of the spring is disposed in a lever groove formed on the fan lever;
rotating the fan lever in a first circumferential direction to a first position associated with an actuated state;
fixing the fan lever to the valve member with the fan lever in the first position; and
rotating the fan lever and valve member from the first position to a second position associated with a base state by the spring.

27. (canceled)
